(19) United States
(12) Patent Application Publication
(10) Pub. No.: US 2020/0136924 A1
(43) Pub. Date: Apr. 30, 2020

(54) Network Device Snapshot

(71) Applicant: HEWLETT PACKARD ENTERPRISE DEVELOPMENT LP, Houston, TX (US)

(72) Inventors: Tathagata Roy, Bangalore (IN); Praveen Krishnakumar Parangattil, Bangalore (IN); Mubeesh Ali Var VM, Bangalore (IN); Arnab Chaudhuri, Bangalore (IN)

(21) Appl. No.: 16/176,832

(22) Filed: Oct. 31, 2018

(51) Int. Cl. H04L 12/24

(52) U.S. Cl. CPC H04L 41/22; H04L 41/046; H04L 41/024; H04L 41/12

(57) ABSTRACT

A method for generating a network device snapshot includes capturing an image of a network device. The method also includes determining an identifier of the network device based on the captured image. Additionally, the method includes requesting logical information about the network device from a network management server for a network of the device, based on the identifier. Further, the method includes determining a plurality of portion identifiers for a corresponding plurality of viewable portions of the network device based on the captured image. Also, the method includes associating a portion of the logical information with each of the viewable portions based on the portion identifiers. The method additionally includes generating a network device snapshot by augmenting each of a plurality of portions of the captured image comprising a corresponding one of the viewable portions with the associated portion of the logical information.

### BACKGROUND

Network devices may be physical, electronic devices that perform functions that enable communication between computing or other electronic devices across communication networks. Network devices may help form the communication networks themselves and connect multiple networks together. Network devices may include switches, routers, servers, access points, and the like. However, network devices may periodically fail for various reasons. As such, it is useful to know the state of network devices when attempting to maintain functional communication networks.

### BRIEF DESCRIPTION OF THE DRAWINGS

The present disclosure may be understood from the following detailed description when read with the accompanying Figures. In accordance with the standard practice in the industry, various features are not drawn to scale. In fact, the dimensions of the various features may be arbitrarily increased or reduced for clarity of discussion.

Some examples of the present application are described with respect to the following figures:

FIG. 1 is an example system for network device snapshots.

FIG. 2 is an example view of a network device snapshot.

FIG. 3 is an example view of a network device snapshot.

FIG. 4 is an example method for generating a network device snapshot.

FIG. 5 is an example system having a tangible, non-transitory computer-readable medium that stores code for generating a network device snapshot.

### DETAILED DESCRIPTION

The state of a network device may include information in both a physical and logical context. The physical context may involve the physical condition of the device, such as which ports have cables plugged into them, what lights may be illuminated on the device, and what color those lights are. The physical context may be significant because, for example, what port a cable is plugged into may determine whether the network device is connected to the correct network. Additionally, lights and their specific colors may indicate whether the network device is operating correctly. Accordingly, having an image of the network device, such as a three-hundred-and-sixty-degree composite may be useful in showing the physical context of the device. The logical context may involve the operational status of the network device. For example, the logical context may describe what network or remote device a particular port is connected to. The networks containing network devices thus may include a network management system (NMS), which can provide logical information about the network's devices. However, accessing an NMS may be a tedious process that involves physically accessing a computer terminal, logging onto the terminal, logging on to the NMS, and navigating a series of menus to access the information that defines a network device's logical context.

Accordingly, examples of the present disclosure may provide a network device snapshot. The network device snapshot may combine an image of the network device that provides the physical context, with information describing the logical context overlaid on the image of the device. The network device snapshot may be presented within an augmented reality presentation that includes a statically stored or a live video capture of the network device. A physical interface, such as a touch screen, or augmented reality head-mounted device may be used to interact with the network device snapshot. In this way, the network device snapshot may be manipulated to view specific portions of the physical network device and view associated network attributes and configurations of the viewed portions. Accordingly, the network device snapshot may provide both the physical and logical context of a network device in a single interface, enabling a detailed analysis of the network device, both while operating and historically.

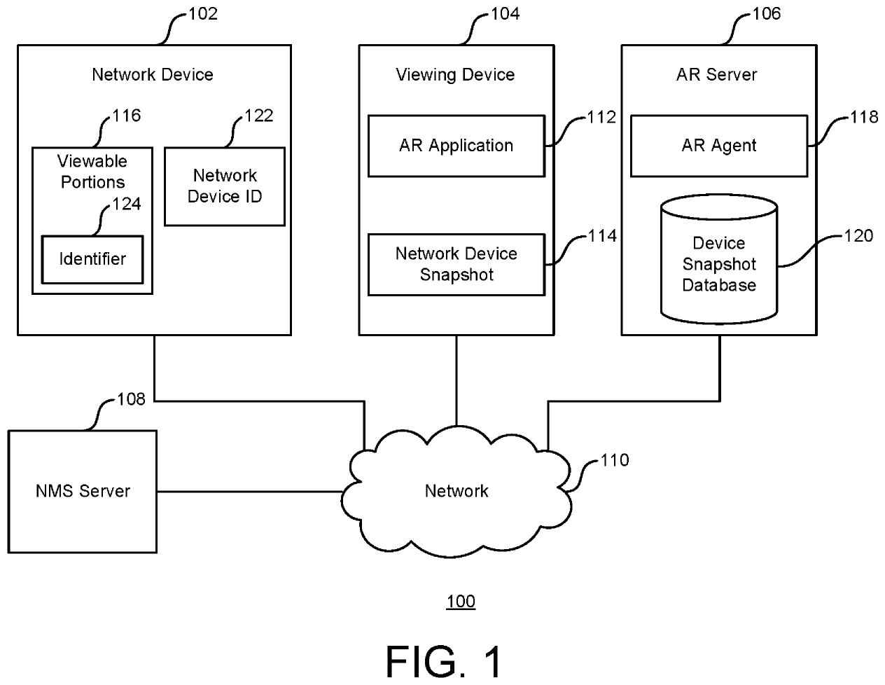

FIG. 1 is an example system for network device snapshots. The system 100 may include a network device 102, a viewing device 104, a network management system (NMS) server 106, and an augmented reality (AR) server 108, in communication over one or more computer and communications networks 110. The networks 110 may include one or more local and wide area networks, including the Internet. The network device 102 may be an electronic device that forms part of one of the networks 110. Accordingly, the network device 102 may be used to facilitate the communication of multiple, remote electronic devices across one or more of the networks 110. Additionally, the network device 102 may include an electronic device that communicates with remote electronic devices across one or more of the networks 110. Example network devices 102 may include network switches, network routers, network servers, and the like.

The viewing device 104 may be an electronic computing device with a general-purpose computer processor or other controller (not shown) that executes an augmented reality application 112 to view and interact with network device snapshots 114. The viewing device 104 may include, for example, a mobile device, such as a tablet or smart phone, a head-mounted augmented reality device, laptop, or desktop computer. The network device snapshots 114 may include a static or live video capture of the network device 102 and logical information that describes the network device 102 or viewable portions 116 thereof. The viewing device 104 may process inputs that manipulate the network device snapshots 114 in order to view the network device 102 at different angles, or zoom into the viewable portions 116. The viewable portions 116 may include specific portions of the network device 102, such as the status lights and ports of a network router.

The augmented reality server 106 may be a computing device having an augmented reality agent 118 and a device snapshot database 120. The augmented reality agent 118 may be software that generates the network device snapshots 114 based on an image or video capture of the network device 102 provided by the viewing device 104 and logical information about the network device 102 provided by the NMS server 108. The logical information may be generated by executing a pre-defined set of queries against the NMS server 108. The queries may be pre-defined based on an application programming interface (API) of the NMS server 108.

In examples, the image of the network device 102 may be captured by a different computing device than the viewing device 104. The augmented reality agent 118 may store the network device snapshots 114 in the device snapshot database 120, which may be a data store capable of storing and retrieving image data and logical data of the network device 102. The device snapshot database 120 may include one or more computer files, an index, or a relational database. Accordingly, the augmented reality agent 118 may provide the network device snapshots 114 to the viewing device 104 by retrieval from the device snapshot database 120. Alternatively, the augmented reality agent 118 may provide the network device snapshots 114 to the viewing device 104 using live video capture of the network device 102 by the viewing device 104, and real-time retrieval of logical information about the network device 102 from the NMS server 108.

The logical information about the network device 102 and viewable portions 114 may be retrievable from the NMS server 106. The NMS server 106 may be one or more computer applications that are useful for monitoring and managing the software and hardware components of one or more of the networks 110. The hardware components of the networks 110 may include the network devices 102. In examples, the augmented reality application 112 may make a request to the augmented reality agent 116 of the augmented reality server 108 to generate and view the network device snapshots 114. The augmented reality agent 118 may include artificial intelligence capable of determining a network device identifier (ID) 122 of the network device 102. The network device ID 122 may be a serial number or other identifying symbol that is viewable on the network device 102, and which may be used to identify the network device 102 to the NMS server 108. Logical information about the network device 102 may be retrieved from the NMS server 108 based on the network device ID 122. Similarly, the viewable portions 116 of the network device 102 may include identifiers 124. The identifiers 124 may include identifying information of the viewable portions 116, such as the media access control (MAC) addresses of ports of the network device 102, that the NMS server 108 may use, in combination with the network device ID 122 to retrieve information about the viewable portions 116. In examples, the augmented realty agent 118 may include artificial intelligence for determining the identifiers 118 of the viewable portions 116.

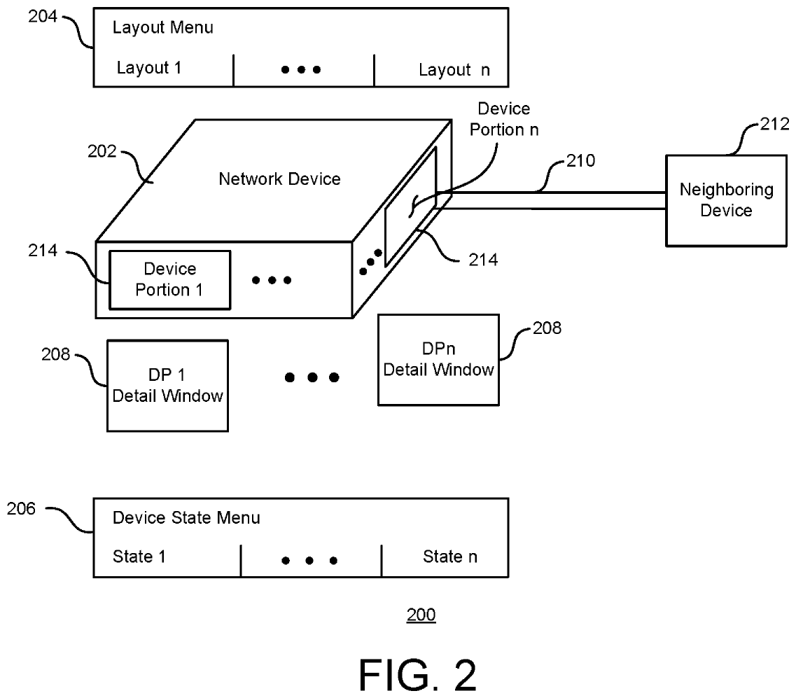

FIG. 2 is an example view 200 of a network device snapshot. The example view 200 includes network device 202, layout menu 204, device state menu 206, device portion detail windows 208, cable 210, and neighboring device 212. The network device 202 may be a communications device, such as a router or switch. The network device 202 may include device portions 214, which may represent various physical elements of the network device 202. For example, the device portions 214 of a router may include ports and lights. Each device portion 214 may be associated with a device portion detail window 208. The device portion detail window 208 may show specific details about the associated device portion 214. For example, the device portion detail window 208 for a port may show configuration or status details about the port. In examples, the layout menu 204 may allow for the selection of a specific layout that determines the type of details shown in the device portion detail window. The layout menu 204 includes layout 1 through layout n, which may represent layouts for configuration, status, and the like. Thus, the view 200 of the network device snapshot may be toggled by making different selections from the layout menu 204. For example, when a configuration layout is selected from the layout menu 204, the configuration details may be shown in the device portion detail windows 216. Additionally, when a status layout is selected from the layout menu 204, the status details may be shown in the device portion detail windows 216.

Similarly, the view 200 may be toggled for different states of the network device 202 by using the device state menu 206. The device state menu 206 may allow for the selection of network device snapshots for different states of the network device 202. The device state menu 206 indicates a number of potential states in which network device snapshots may be captured. For example, a network device snapshot may be generated when the network device 202 is in a known good state. In this way, the network device snapshot from the known good state may be used as a point of comparison against which errors with the network device 202 may be diagnosed and resolved. Accordingly, a network device snapshot may also be generated for the network device 202 for a state of error, such as a current state. Thus, by selecting the current state from the device state menu 206, the device portion detail windows 208 may be updated with layout-specific details based on a network device snapshot generated when the network device 202 is in its current state. Similarly, by selecting the known good state from the device state menu 206, the device portion detail windows 216 may be updated with layout-specific details based on a network device snapshot generated when the network device 202 is in a known good state.

The network device snapshot may also include one or more neighboring devices 212 that may be connected to the network device 202 by a cord 210, for example. The cord 210 may be an ethernet cable, fiber optic cable, coaxial cable, and the like.

In examples, the captured image of the network device 102 may include a three-hundred-and-sixty-degree composite image. Accordingly, the view 200 of the network device snapshot may be manipulated to provide perspectives of the network device 102 from different angles. For example, the view 200 may be presented on a head-mounted device. In such a presentation, the perspective of the view 200 may be changed by changing the orientation of the head-mounted device with a turn of the head on which the device is mounted. As the head-mounted device is turned, the perspective of the view 200 may change in an associated direction. Thus, by turning the head-mounted device to the right, the perspective may shift in a rightward rotation around the network device 202. Similarly, by turning the head-mounted device to the left, the perspective may shift in a leftward rotation around the network device 202.

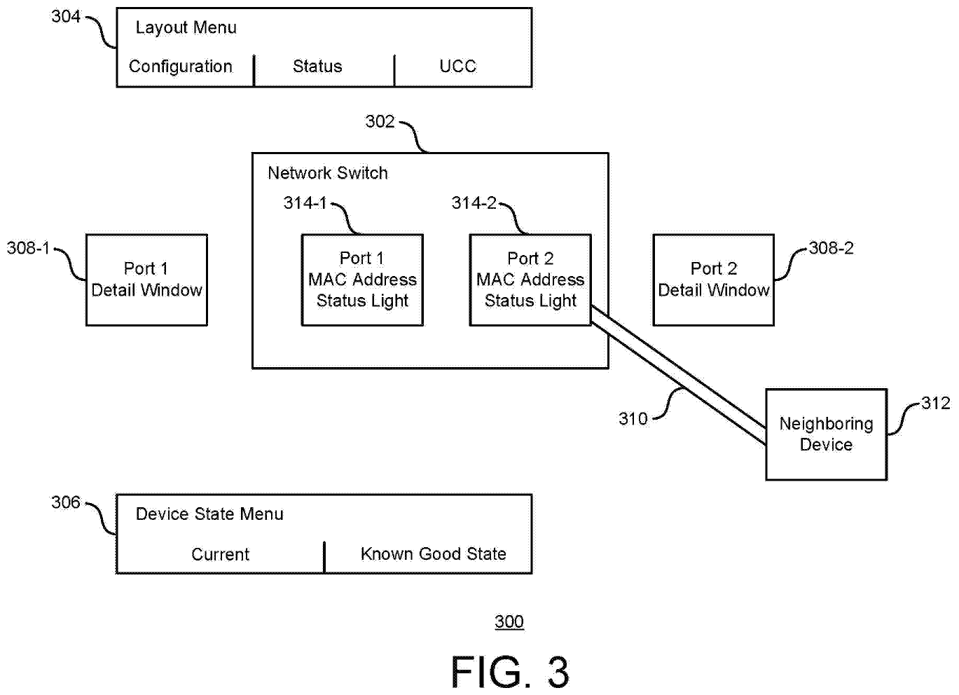

FIG. 3 is an example view 300 of a network device snapshot. The example view 300 includes a network switch 302, layout menu 304, device state menu 306, port detail windows 308, cable 310, and neighboring device 312. The network switch 302 may include ports 314. The ports 314 may include a physical port, a MAC address, and a status light. The status light may represent the power over Ethernet status of the port 314. Each port 314 may be associated with one of the port detail windows 308. The port detail windows 308 may show specific details about the associated port 314 based on the layout selected in the layout menu 304. The layout menu 304 includes layouts for configuration, status, and unified communication and collaboration (UCC) details. The UCC details are related to a communication standard for desktop-style sharing applications, whereby documents, video, and whiteboard-related information may be shared between multiple users connected over a network. Thus, the view 300 of the network device snapshot may be toggled by making different selections from the layout menu 304. For example, when a configuration layout is selected from the layout menu 304, the configuration details may be shown in the port detail windows 308. Additionally, when a status layout is selected from the layout menu 304, the status details may be shown in the port detail windows 308.

Similarly, the view 300 may be toggled for different states of the network device 302 by using the device state menu 306. The device state menu 306 may allow for the selection of network device snapshots for different states of the network device 302. In examples, by selecting the current state from the device state menu 306, the port detail windows 308 may be updated with layout-specific details based on a network device snapshot generated when the network device 302 is in its current state. Similarly, by selecting the known good state from the device state menu 306, the port detail windows 308 may be toggled to show with layout-specific details based on a network device snapshot generated when the network device 302 is in a known good state.

The network device snapshot may also include one or more neighboring devices 312 that may be connected to the network device 302 by a cord 310, for example. The cord 310 may be an ethernet cable, fiber optic cable, coaxial cable, and the like.

In examples, the captured image of the network device 102 may include a three-hundred-and-sixty-degree composite image. Accordingly, the view 300 of the network device snapshot may be manipulated to provide perspectives of the network device 102 from different angles. For example, the view 300 may be presented on a touch screen interface. In such a presentation, the perspective of the view 300 may be changed by changing sliding a touch input device across the screen. As the touch input device moves across the screen, the perspective of the view 300 may change in an associated direction. Thus, by sliding the touch input device to the right, the perspective may shift in a rightward rotation around the network device 302. Similarly, by sliding the touch input device to the left, the perspective may shift in a leftward rotation around the network device 302.

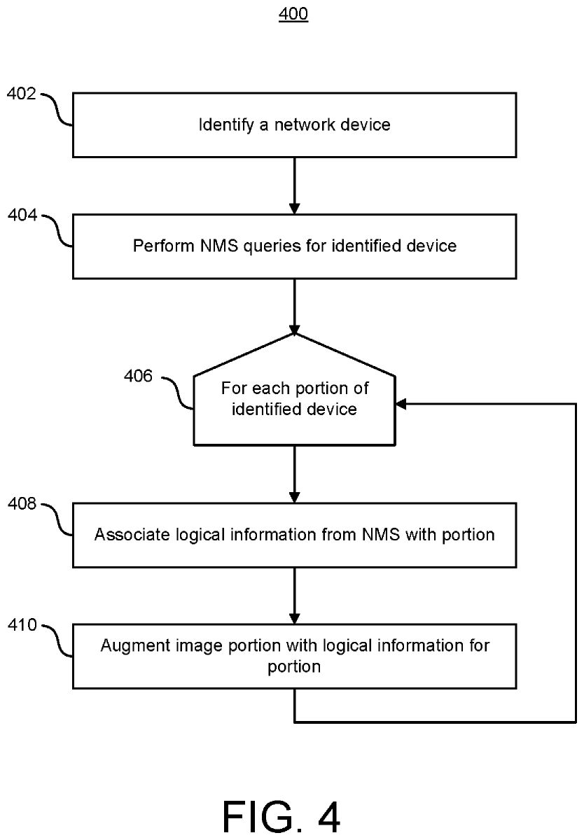

FIG. 4 is an example method 400 for generating a network device snapshot. In examples, the method 400 may be performed by the augmented reality agent 118. At block 402, the augmented reality agent 118 may identify a network device, such as the network device 102. The network device 102 may be identified based on an image capture of the network device 102. The image capture may include a network device ID, such as a serial number. In examples, the augmented reality agent 118 may use image recognition to determine the serial number of the network device 102 by analyzing the captured image.

At block 404, the augmented reality agent 118 may perform a predefined set of NMS queries for the identified network device 102. The NMS queries may be performed using an API for an NMS server, such as the NMS server 108. The NMS queries may retrieve logical information about the network device 102. The logical information may include configuration and status information about the network device 102 and the viewable portions 116.

Blocks 406 through 410 may be performed for each viewable portion 116 of the network device. At block 408, the augmented reality agent 118 may associate logical information from the NMS server 108 with the viewable portion 116. The association may be determined by using image recognition to uniquely identify each of the viewable portions 116. For example, for a device port, the image capture may include the MAC address of the port. Accordingly, the configuration and status information for the recognized MAC address may be associated with the port having that MAC address.

At block 410, the portion of the captured image for the viewable portion may be augmented with the associated logical information. The associated logical information may include the meaning of the particular colors of lights on the network device 102, such as port power lights. The image may be augmented with a detail window containing the logical information. The detail window may be located near the viewable portion 116 in the augmented image.

Blocks 408 through 410 may be repeated for each viewable portion 116 of the network device 102. In this way, by augmenting the captured image of the network device 102 with logical information for each of the viewable portions, the network device snapshot may be generated.

It is to be understood that the process flow diagram of FIG. 4 is not intended to indicate that the method 400 is to include all of the blocks shown in FIG. 4 in every case. Further, any number of additional blocks can be included within the method 400, depending on the details of the specific implementation. In addition, it is to be understood that the process flow diagram of FIG. 4 is not intended to indicate that the method 400 is only to proceed in the order indicated by the blocks shown in FIG. 4 in every case. For example, block 404 can be rearranged to occur before block 402.

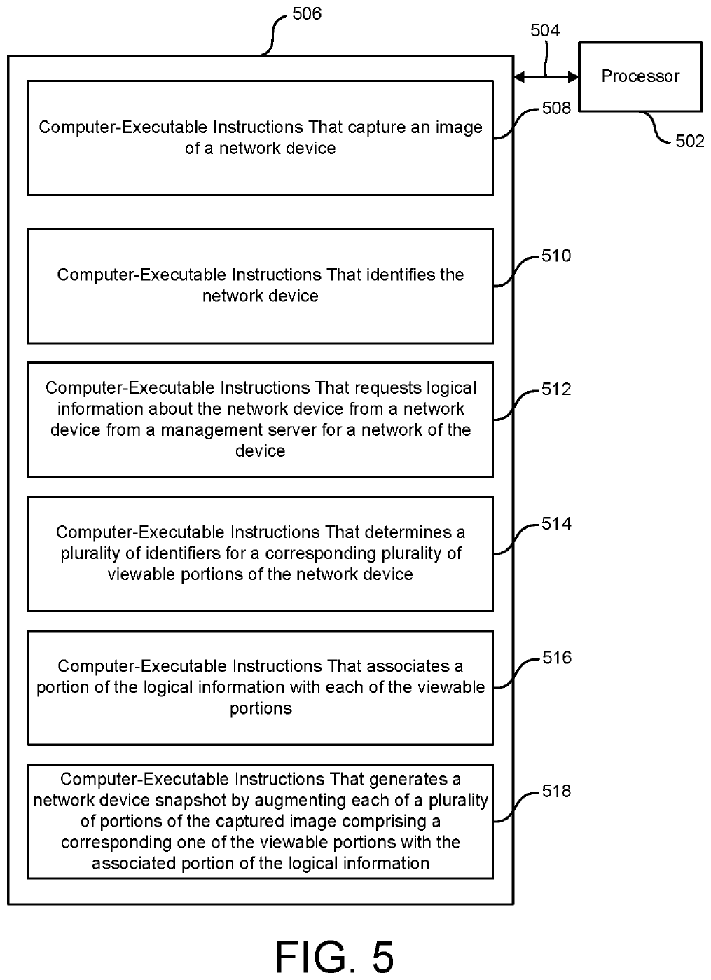

FIG. 5 is an example system 500 having a tangible, non-transitory computer-readable medium 502 that stores code for network testing. The tangible, non-transitory computer-readable medium is generally referred to by the reference number 502. The tangible, non-transitory computer-readable medium 502 may correspond to any typical computer memory that stores computer-implemented instructions, such as programming code or the like. For example, the tangible, non-transitory computer-readable medium 502 may include RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

The tangible, non-transitory computer-readable medium 502 can be accessed by a processor 504 over a computer bus 506. A region 508 of the tangible, non-transitory computer-readable medium 502 stores computer-executable instructions that capture an image of a network device. A region 510 of the tangible, non-transitory computer-readable medium 502 stores computer-executable instructions that identifies the network device. A region 512 of the tangible, non-transitory computer-readable medium 502 stores computer-executable instructions that requests logical information about the network device from a network management server for a network of the device. A region 514 of the tangible, non-transitory computer-readable medium 502 stores computer-executable instructions that determines a plurality of identifiers for a corresponding plurality of viewable portions of the network device. A region 516 of the tangible, non-transitory computer-readable medium 502 stores computer-executable instructions that associates a portion of the logical information with each of the viewable portions. A region 518 of the tangible, non-transitory computer-readable medium 502 stores computer-executable instructions that generates a network device snapshot by augmenting each of a plurality of portions of the captured image comprising a corresponding one of the viewable portions with the associated portion of the logical information.

Although shown as contiguous blocks, the software components can be stored in any order or configuration. For example, if the tangible, non-transitory computer-readable medium 502 is a hard drive, the software components can be stored in non-contiguous, or even overlapping, sectors.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method for generating a network device snapshot, comprising:
capturing an image of a network device;
determining an identifier of the network device based on the captured image;
requesting logical information about the network device from a network management server for a network of the device, based on the identifier;
determining a plurality of portion identifiers for a corresponding plurality of viewable portions of the network device based on the captured image;
associating a portion of the logical information with each of the viewable portions based on the portion identifiers; and
generating a network device snapshot by augmenting each of a plurality of portions of the captured image comprising a corresponding one of the viewable portions with the associated portion of the logical information.

2. The method of claim 1, comprising presenting the network device snapshot with a layout menu comprising a plurality of layout selections.

3. The method of claim 2, wherein the associated portion of the logical information that is presented is based on a layout selection from the layout menu.

4. The method of claim 2, comprising storing the network device snapshot in association with a device state.

5. The method of claim 4, wherein the device state comprises a known good state.

6. The method of claim 5, comprising:
capturing a current image of a network device;
determining the identifier of the network device based on the captured image;
requesting current logical information about the network device from the network management server, based on the identifier;
determining the plurality of portion identifiers for the corresponding plurality of viewable portions of the network device based on the captured image;
associating a current portion of the current logical information with each of the viewable portions based on the portion identifiers;
generating a current network device snapshot by augmenting each of a current plurality of portions of the captured current image comprising a corresponding current one of the viewable portions with the associated current portion of the current logical information; and
storing the current network device snapshot in association with a current state.

7. The method of claim 1, comprising presenting a device state menu comprising a plurality of device state selections.

8. The method of claim 7, comprising toggling a view of the network device snapshot with a view of the current network device snapshot in response to a selection from the device state menu.

9. The method of claim 1, wherein the logical information comprises:
a device configuration of the network device;
a device status of the network device;
a corresponding plurality of portion configurations of the viewable portions; and
a corresponding plurality of portion statuses of the viewable portions.

10. A system, comprising:
a processor that executes stored instructions; and
a memory device that stores instructions that cause the processor to:
capture an image of a network device;
determine an identifier of the network device based on the captured image;
request logical information about the network device from a network management server for a network of the device, based on the identifier;
determine a plurality of portion identifiers for a corresponding plurality of viewable portions of the network device based on the captured image;
associate a portion of the logical information with each of the viewable portions based on the portion identifiers;
generate a network device snapshot by augmenting each of a plurality of portions of the captured image comprise a corresponding one of the viewable portions with the associated portion of the logical information; and
present the network device snapshot with a layout menu comprising a plurality of layout selections.

11. The system of claim 10, wherein the associated portion of the logical information that is presented is based on a layout selection from the layout menu.

12. The system of claim 10, wherein the instructions cause the processor to store the network device snapshot in association with a device state, wherein the device state comprises a known good state.

13. The system of claim 12, wherein the instructions cause the processor to:
capture a current image of a network device;
determine the identifier of the network device based on the captured image;
request current logical information about the network device from the network management server, based on the identifier;
determine the plurality of portion identifiers for the corresponding plurality of viewable portions of the network device based on the captured image;
associate a current portion of the current logical information with each of the viewable portions based on the portion identifiers;
generate a current network device snapshot by augmenting each of a current plurality of portions of the captured current image comprise a corresponding current one of the viewable portions with the associated current portion of the current logical information;
store the current network device snapshot in association with a current state; and
present a device state menu comprise a plurality of device state selections.

14. The system of claim 13, wherein the instructions cause the processor to toggle a view of the network device snapshot with a view of the current network device snapshot in response to a selection from the device state menu.

15. The system of claim 10, wherein the logical information comprises:
a device configuration of the network device;
a device status of the network device;
a corresponding plurality of portion configurations of the viewable portions; and
a corresponding plurality of portion statuses of the viewable portions.

16. A non-transitory, computer-readable medium storing computer-executable instructions, which when executed, cause a computer to:
capture an image of a network device;
determine an identifier of the network device based on the captured image;
request logical information about the network device from a network management server for a network of the device, based on the identifier;
determine a plurality of portion identifiers for a corresponding plurality of viewable portions of the network device based on the captured image;
associate a portion of the logical information with each of the viewable portions based on the portion identifiers;
generate a network device snapshot by augmenting each of a plurality of portions of the captured image comprise a corresponding one of the viewable portions with the associated portion of the logical information; and
present the network device snapshot with a layout menu comprising a plurality of layout selections, wherein the associated portion of the logical information that is presented is based on a layout selection from the layout menu.

17. The non-transitory, computer-readable medium of claim 16, wherein the computer-executable instructions cause the computer to store the network device snapshot in association with a device state, wherein the device state comprises a known good state.

18. The non-transitory, computer-readable medium of claim 17, wherein the computer-executable instructions cause the computer to:
capture a current image of a network device;
determine the identifier of the network device based on the captured image;
request current logical information about the network device from the network management server, based on the identifier;
determine the plurality of portion identifiers for the corresponding plurality of viewable portions of the network device based on the captured image;
associate a current portion of the current logical information with each of the viewable portions based on the portion identifiers;
generate a current network device snapshot by augmenting each of a current plurality of portions of the captured current image comprise a corresponding current one of the viewable portions with the associated current portion of the current logical information;
store the current network device snapshot in association with a current state; and
present a device state menu comprise a plurality of device state selections.

19. The non-transitory, computer-readable medium of claim 18, wherein the computer-executable instructions cause the computer to toggle a view of the network device snapshot with a view of the current network device snapshot in response to a selection from the device state menu.

20. The non-transitory, computer-readable medium of claim 16, wherein the logical information comprises:
a device configuration of the network device;
a device status of the network device;
a corresponding plurality of portion configurations of the viewable portions; and
a corresponding plurality of portion statuses of the viewable portions.
